(19) United States
(12) Patent Application Publication
(10) Pub. No.: US 2017/0285434 A1
(43) Pub. Date: Oct. 5, 2017

(54) ELECTRONIC PAPER DISPLAY MODULE, METHOD FOR MAKING SAME AND ELECTRONIC PAPER DISPLAY DEVICE

(71) Applicant: Johnson Electric S.A., Murten (CH)

(72) Inventors: Song QIAN, Shang Hai (CN); Steven Eric DEAN, Intervale, NH (US)

(21) Appl. No.: 15/471,637

(22) Filed: Mar. 28, 2017

(30) Foreign Application Priority Data
Apr. 1, 2016 (CN) 2016 1020 2699.9

(51) Int. Cl. G02F 1/167; G02F 1/133; G02F 1/1333

(52) U.S. Cl. CPC G02F 1/167; G02F 1/133345; G02F 1/13306; G02F 2201/50

(57) ABSTRACT

An electronic paper display module includes a substrate, a circuit layer disposed on one side of the substrate, an insulating layer disposed on the substrate and the circuit layer, an electronic paper display layer disposed on one side of the insulating layer opposite from the circuit layer and partially passes through the insulating layer to electrically connect with the circuit layer, an electrical connecting member, and a top protective layer disposed on the insulating layer and the electronic paper display layer. The top protective layer, insulating layer and circuit layer cooperatively seal the electronic paper display layer. The circuit layer, insulating layer, electrical connecting member and substrate cooperatively seal the circuit layer. A method for making the electronic paper display module and an electronic paper display device are also provided. A bottom protective layer is no longer required, which simplifies the fabrication process and reduces cost.

### CROSS REFERENCE TO RELATED APPLICATIONS

This non-provisional patent application claims priority under 35 U.S.C. §119(a) from Patent Application No. 201610202699.9 filed in The People's Republic of China on Apr. 1, 2016.

### FIELD OF THE INVENTION

This present disclosure relates to electronic paper display technology, and in particular to an electronic paper display module, a method for making the electronic paper display module, and an electronic paper display device utilizing the electronic paper display module.

### BACKGROUND OF THE INVENTION

Electrophoretic electronic papers have a high contrast and a wide view angle. Characters and images displayed by the electrophoretic electronic papers do not disappear immediately when the power is suddenly cut off. In addition, the electrophoretic electronic papers are easily bendable, and do not need backlight and continuous charging. Due to these characteristics, the electrophoretic electronic papers are becoming more and more widely used, for example, in books, printing medium for paper or magazine, foldable screens, or electronic wallpapers.

The electronic paper display device typically includes a housing, a main board mounted in the housing, and an electronic paper display module mounted in the housing and electrically connected with the main board. Referring to FIG. 1, an existing electronic paper display module 500 includes a substrate 510, a circuit layer 500 disposed on a lower surface of the substrate 510, an electronic paper display layer 530 disposed on an upper surface of the substrate 510, a top protective layer 540 disposed on the upper surface of the substrate 510 and sealing an upper surface and four sides of the electronic paper display layer 530, a bottom protective layer 550 disposed on a lower surface of the substrate 510 and sealing three side surfaces and a portion of a lower surface of the circuit layer 520, and an insulating layer 560 and an electrical connecting member 570 disposed on the lower surface of the circuit layer 520. The electronic paper display layer 530 passes through a through hole 512 defined in the substrate 510 to electrically connect with the circuit layer 520. The lower surface of the circuit layer 520 is partially covered by the insulating layer 560. The bottom protective layer 550, the insulating layer 560 and the electrical connecting member 570 cooperatively seal the lower surface of the circuit layer 520.

The electronic paper display layer 530 includes an electronic paper display screen 532 and an image layer 535 that are stacked with each other. The electronic paper display screen 532 is used to display characters or images. Characters or images to be displayed by the electronic paper display layer 530 are printed on the image layer 535, and the image layer 535 is electrically connected with the circuit layer 520. The electrical connecting member 570 is used to electrically connect the circuit layer 520 with the main board of the electronic paper display device or with an external power supply to supply power to the circuit layer 520.

In making the electronic paper display module 500, the substrate 510 is first provided, wherein the substrate 510 is made from polyethylene terephthalate (PET). A hole is drilled through the substrate 510. Conductive silver paste is printed on the lower surface of the substrate 510 to form the circuit layer 520. Conductive carbon paste is printed on the lower surface of the circuit layer 520 to form the electrical connecting member 570. Conductive carbon paste is printed on the upper surface of the substrate 510 to form the image layer 535. The insulating layer 560 is formed on the lower surface of the circuit layer 520 by printing. The electronic paper display screen 532 is affixed to the upper surface of the image layer 535 and is pressed to securely connect with the image layer 535. The resulted assembly is stored in an environment having a temperature of 25 degrees and a relative humidity of 50%, so as to maintain the relative humidity of ink layer of the electronic paper display screen at 50%±5%. The bottom protective layer 550 is affixed to the lower surface of the circuit layer 520, and the bottom protective layer 550, the insulating layer 560 and the electrical connecting member 570 completely cover the lower surface of the circuit layer 520. The top protective layer 540 is affixed to the upper surface of the electronic paper display screen 532. The top protective layer 540 and the bottom protective layer 550 are pressed to make the top protective layer 540 seal the upper surfaces and four sides of the electronic paper display layer 530 and make the bottom protective layer 550 seal the lower surface and three adjacent side surfaces of the circuit layer 520. Finally, a circumferential edge of the electronic paper display module 500 is punched to make it have a shape as desired.

In the above process of making the electronic paper display module 500, in order to maintain the relative humidity of the ink layer of the electronic paper display screen 532 at 50%±5%, the top protective layer 540 and the bottom protective layer 550 are required to be affixed to the upper and lower surfaces of the substrate 510, respectively, to seal the circuit layer 520 and the electronic paper display layer 530, thereby isolating them from outside air and preventing them from getting damp. However, because of the top protective layer 540 and the bottom protective layer 550 affixed to the upper and lower surfaces of the substrate 510, the process of making the electronic paper display module 500 can be complex, which increases the manufacturing cost. In addition, the protective layers have high cost and, therefore, the use of the top protective layer 540 and the bottom protective layer 550 increases the material cost.

### SUMMARY OF THE INVENTION

Accordingly, there is a desire for a simplified method of making an electronic paper display module, an electronic paper display module with reduced cost, and an electronic paper display device employing the electronic paper display module.

In one aspect, an electronic paper display module is provided which includes a substrate, a circuit layer, an insulating layer, an electronic paper display layer, an electrical connecting member, and a top protective layer. The circuit layer is disposed on one side of the substrate. The insulating layer is disposed on the substrate and the circuit layer. The electronic paper display layer is disposed on one side of the insulating layer opposite from the circuit layer and partially passes through the insulating layer to electrically connect with the circuit layer. The top protective layer is disposed on the insulating layer and the electronic paper display layer. The top protective layer, the insulating layer and the circuit layer cooperatively seal the electronic paper display layer to isolate it from outside air. The circuit layer, the insulating layer, the electrical connecting member and the substrate cooperatively seal the circuit layer to isolate it from outside air.

Preferably, the substrate comprises a thin metal sheet and two protective films disposed on opposite sides of the thin metal sheet, and the circuit layer is disposed on one side of one of the two protective films opposite from the thin metal sheet.

Preferably, the two protective films are adhered to the thin metal sheet with adhesive.

Preferably, the substrate comprises a metal sputtered base plate and two protective films on opposite sides of the metal sputtered base plate, and the circuit layer is disposed on one side of one of the two protective films opposite from the metal sputtered base plate.

Preferably, the metal sputtered base plate comprises a metal layer formed on its surface through a sputter deposition process.

Preferably, a material of the protective film is one of polycarbonate, polymethyl methacrylate, polyethylene terephthalate, polyethersulfone, cellulose ester, polyvinyl chloride, benzocyclobutene and acrylic resin.

Preferably, the electronic paper display module comprises an image layer and an electronic paper display screen. The image layer is disposed on the insulating layer and partially passes through the insulating layer to electrically connect with the circuit layer. The image layer is pre-formed with images or characters that the electronic paper display module needs to display, and the electronic paper display screen is stacked on the image layer.

Preferably, the electronic paper display screen is one of a micro-capsule electrophoretic screen, a microcup electrophoretic screen, a gyricon bead electrophoretic screen, and a partition electrophoretic screen.

Preferably, the image layer is made of conductive carbon paste ink or metal.

Preferably, the electrical connecting layer is made of conductive carbon paste ink or metal, the circuit layer is made of conductive silver paste ink or metal, and the insulating layer is made of insulating ink or resin.

In another aspect, an electronic paper display device is provided which employs the above-described electronic paper display module.

In still another aspect, a method for making an electronic paper display module is provided which includes the steps of: providing a substrate; forming a circuit layer on one side of the substrate; forming an insulating layer on the substrate and the circuit layer, with part of the circuit layer exposed outside the insulating layer; forming an image layer on one side of the insulating layer opposite from the circuit layer according to a preset image, with the image layer partially passing through the insulating layer to electrically connect with the circuit layer; forming an electrical connecting member on the circuit layer, wherein the electrical connecting member, the image layer, the insulating layer and the substrate cooperatively seal the circuit layer to isolate it from outside air; providing an electric paper display screen, and affixing and pressing the electronic paper display screen onto one side of the image layer opposite from the insulating layer; storing the electronic paper display module thus formed in an environment having a temperature of 25 degrees and a relative humidity of 50%, such that the relative humidity of electronic ink in the electronic paper display screen is maintained at 50%+5%; and forming a top protective layer on the electronic paper display screen and the insulating layer, wherein the top protective layer, the insulating layer and the circuit layer cooperatively seals the electronic paper display screen to isolate it from outside air.

Preferably, the circuit layer is formed by printing a conductive silver paste ink, or from a metal material through a sputtering, pressing, etching or laser process.

Preferably, the insulating layer is formed by printing an insulating ink, or by affixing and pressing or coating resin.

Preferably, the image layer is formed by printing a conductive carbon paste ink, or from a metal material through a sputtering, pressing, etching or laser process.

Preferably, the electrical connecting member is formed by printing a conductive carbon paste ink, or made from metal.

Preferably, the method further comprises the step of punching the electronic paper display module according to a preset shape after the top protective film is formed.

In the method for making the electronic paper display module of the present invention, the damp-resistant substrate is provided, and the circuit layer, the insulating layer and the electronic paper display layer are sequentially disposed on one side of the substrate, such that the circuit layer and the electronic paper display layer 70 can be sealed simply by affixing the top protective layer to the electronic paper display module, thereby maintaining the relative humidity of the electronic ink in the electronic paper display layer at 50%±5%. In comparison with the prior art, in making the electronic paper display module, adhering the bottom protective layer is no longer required, which simplifies the fabrication process and reduces the cost.

### BRIEF DESCRIPTION OF THE DRAWINGS

FIG. 1 is a sectional view of a conventional electronic paper display module.

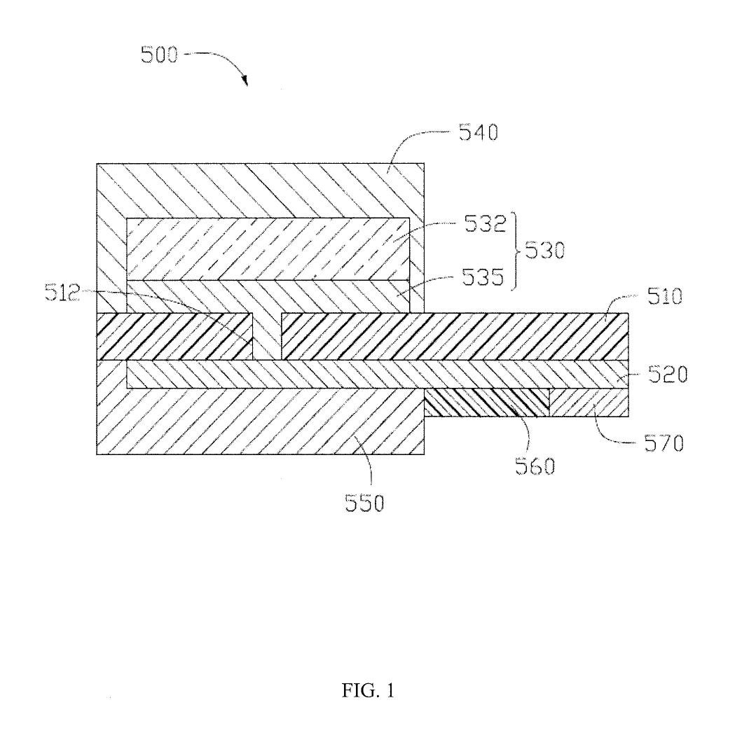

FIG. 2 is a perspective view of an electronic paper display device including an electronic paper display module according to one embodiment.

FIG. 3 is a sectional view of the electronic paper display module according to one embodiment.

FIG. 4 is a sectional view of the electronic paper display module according to another embodiment.

FIG. 5 a flow chart of a method for making the electronic paper display module according to one embodiment.

Below, embodiments of the present invention will be described in detail with reference to the accompanying drawings.

### DETAILED DESCRIPTION OF THE PREFERRED EMBODIMENTS

Various embodiments of the present invention will be described with reference to the accompanying drawings. In the description and drawings, like reference numerals designate like elements. It should be noted that the figures are merely illustrative rather than restrictive. It also should be noted that the figures are only intended to facilitate the description and are not drawn to scale. Unless otherwise specified, all technical and scientific terms have the ordinary meaning as understood by people skilled in the art.

It is noted that, when a component is described to be “connected” to another component, it can be directly connected to the another component or there may be an intermediate component. When a component is described to be “disposed” on another component, it can be directly disposed on the another component or there may be an intermediate component. The terms used herein such as “top layer”, “upper surface”, “lower surface”, “side surface” or similar expressions are for the purposes of illustration only.

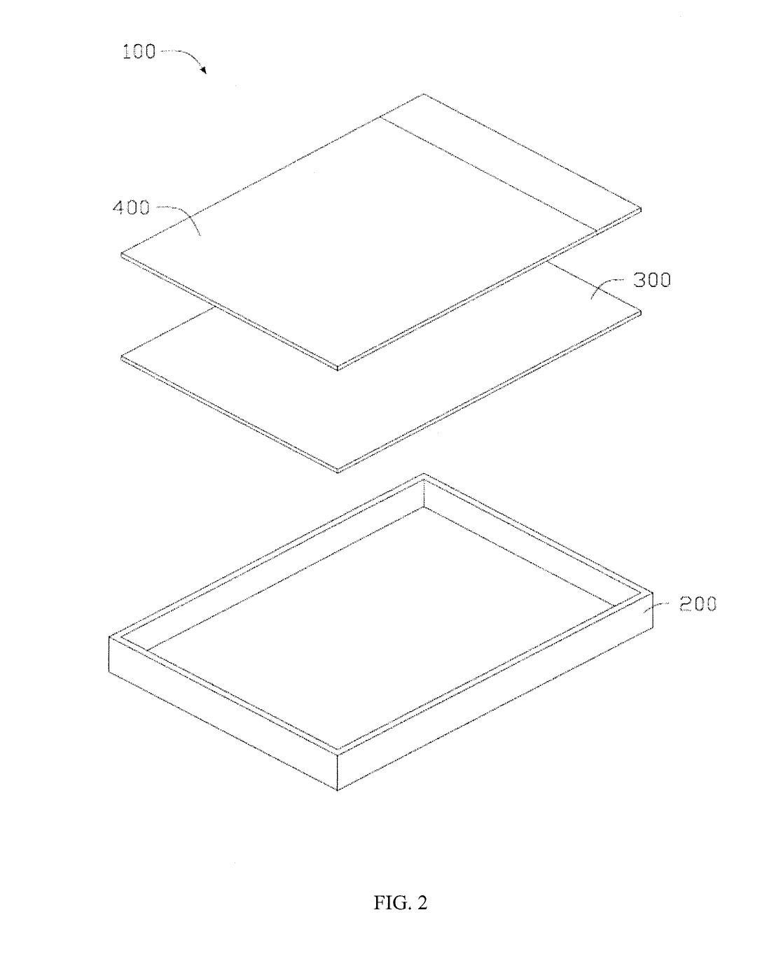

FIG. 2 illustrates an electronic paper display device according to one embodiment. The electronic paper display device 100 of this embodiment includes a housing 200, a main board 300 received in the housing 200, and an electronic paper display module 400 received in the housing 200 and electrically connected with the main board 300. In this invention, the electronic paper display device 100 may be a display device such as a cell phone, a tablet PC or a television set. It should be understood that the electronic paper display device 100 further includes other common components of the display device which are not described herein in detail to reduce the length of this disclosure. The electronic paper display module 400 of this invention may be used independently, which may be an electronic paper or an electronic billboard.

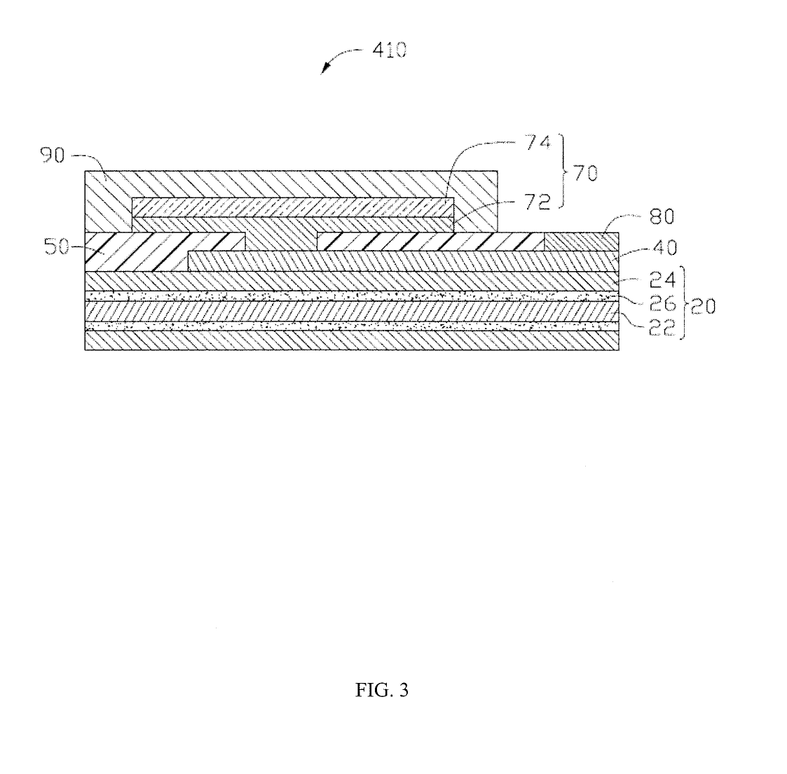

FIG. 3 is a sectional view of an electronic paper display module according to one embodiment. In the embodiment, the electronic paper display module 410 includes a substrate 20, a circuit layer 40, an insulating layer 50, an electronic paper display layer 70, an electrical connecting member 80, and a top protective layer 90. In the embodiment, specifically, the circuit layer 40 is disposed on an upper surface of the substrate 20. The insulating layer 50 is disposed on an upper surface of the circuit layer 40 and seals three side surfaces of the circuit layer 40. The electronic paper display layer 70 is disposed on an upper surface of the insulating layer 50 and is electrically connected with the circuit layer 40 through a through hole of the insulating layer 50. The electrical connecting member 80 is disposed on the circuit layer 40. The insulating layer 50, the electronic paper display layer 70 and the electrical connecting member 80 cooperatively seal the upper surface of the circuit layer 40. The top protective layer 90 is disposed on the upper surface of the insulating layer 50 and seals the upper surface and four side surfaces of the electronic paper display layer 70. The insulating layer 50, the top protective layer 90, the electrical connecting member 80, and the substrate 20 cooperatively seal the top and lower surfaces and three adjacent side surfaces of the circuit layer 40 to isolate them from outside air, thus preventing them from getting oxidized and damp. The top protective layer 90, the insulating layer 50 and the substrate 20 cooperatively seal the electronic paper display layer 70 to isolate it from outside air, thus preventing it from getting damp.

In the embodiment, the substrate 20 includes a thin metal sheet 22 and two protective films 24 disposed on upper and lower surfaces of the thin metal sheet 22. The thin metal sheet 22 may be made from a metal material such as aluminum, copper or tinned copper. The protective film 24 is adhered to the thin metal sheet 22 with adhesive 26. The protective film 24 may be made from a transparent flexible material such as plastic or resin. Specifically, the material of the protective film 24 may be polyester such as polycarbonate (PC), polymethyl methacrylate (PMMA) or polyethylene terephthalate (PET), or polyethersulfone (PES), cellulose ester, polyvinyl chloride (PVC), benzocyclobutene (BCB) or acrylic resin. Preferably, in the embodiment, the protective film 24 is a PET layer.

In this embodiment, the circuit layer 40 is formed by printing a conductive silver paste ink on one side of one protective film 24 opposite from the thin metal sheet 22. It should be understood that, in other embodiments, the circuit layer 40 may be formed from a metal material such as copper, aluminum or nickel, via a sputtering, pressing, etching or laser process.

In this embodiment, the insulating layer 50 is formed by printing an insulating ink. It should be understood that, in another embodiment, the insulating layer 50 may be formed by adhering or coating an insulating material such as resin on the circuit layer 40. The insulating layer 50 is disposed on the upper surfaces of the substrate 20 and the circuit layer 40 according to a preset pattern and seals three adjacent side surfaces of the circuit layer to prevent the circuit layer 400 from getting oxidized or damp by the outside environment. According to the preset pattern, the insulating layer 50 exposes a portion of the upper surface of the circuit layer 40 adjacent its side surface, for mounting the electrical connecting member 80. In addition, a portion of the upper surface of the circuit layer 40 close to a central area thereof is exposed outside the insulating layer 50, for allowing a part of the electronic paper display layer 70 to pass through the insulating layer 50 to electrically connect with the circuit layer 40. It should be understood that, in other embodiments, the insulating layer 50 may completely cover the upper surface of the circuit layer 40, and a hole is drilled through the insulating layer 50 to expose the portion of the upper surface of the circuit layer 40 close to the central area or an edge thereof.

In this embodiment, the electronic paper display layer 70 includes an image layer 72 and an electronic paper display screen 74. The image layer 72 is disposed on the upper surface of the insulating layer 50 and partially passes through the insulating layer 50 to electrically connect with the circuit layer 40. The image layer 72 is formed by printing a conductive carbon paste ink, on which all figures or characters that the electronic paper display module 410 needs to display are pre-formed. It should be understood that, in other embodiments, the image layer 72 may also be formed from a metal material through a sputtering, pressing, or etching process. The electronic paper display screen 74 is affixed to and completely covers an upper surface of the image layer 72, and has the same size as the image layer 72. The electronic paper display screen 74 may be an existing electrophoretic screen such as, but not limited to, one of a micro-capsule electrophoretic screen, a microcup electrophoretic screen, a gyricon bead electrophoretic screen, and a partition electrophoretic screen.

In this embodiment, the electrical connecting member 80 is formed by printing a conductive carbon paste ink. It should be understood that, in other embodiments, the electrical connecting member 80 may be formed from another conductive material such as metal.

In this embodiment, the top protective layer 90 is disposed on the upper surfaces of the electronic paper display screen 74 and the insulating layer 50 and completely seals the upper surface and four side surfaces of the electronic paper display screen 74 and four side surfaces of the image layer 72. The top protective layer 90, the insulating layer 50, and the circuit layer 40 cooperatively seal the electronic paper display layer to isolate it from outside air and prevent it from getting damp, thereby maintaining a relative humidity of electronic ink in the electronic paper display screen 74 at 50%+5%. A material of the top protective layer 90 may be a polyester such as polycarbonate (PC), polymethyl methacrylate (PMMA) or polyethylene terephthalate (PET), or polyethersulfone (PES), cellulose ester, polyvinyl chloride (PVC), benzocyclobutene (BCB) or acrylic resin. Preferably, in this embodiment, the top protective layer 90 is a PET layer.

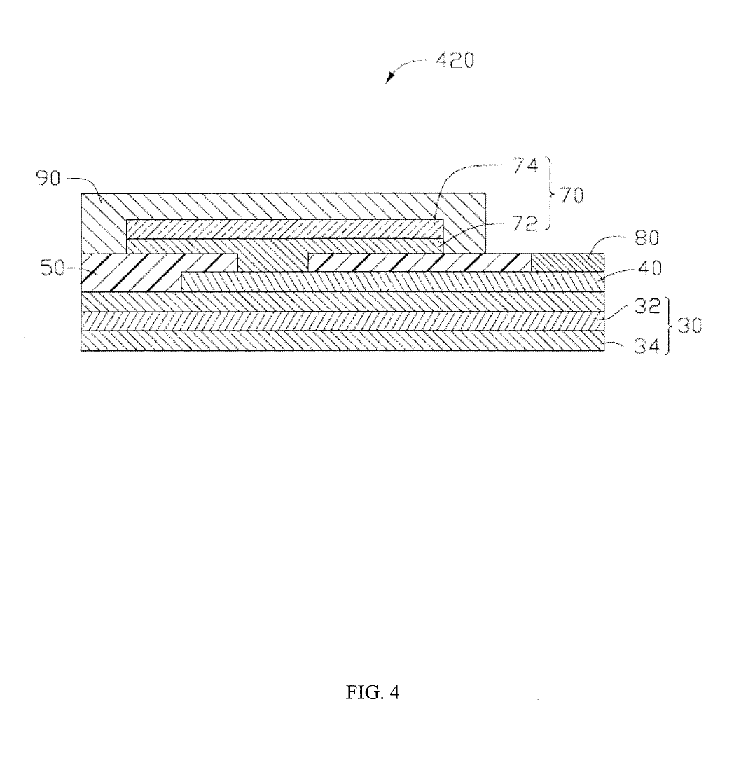

FIG. 4 is a side view of an electronic paper display module according to another embodiment of the present invention. In the second embodiment, the electronic paper display module 420 has generally the same construction as the electronic paper display module 410 of the first embodiment, except that the substrate 30 of the electronic paper display module 420 includes a metal sputtered base plate 32 and two protective films 34 disposed on upper and lower surfaces of the metal sputtered base plate 32. The metal sputtered base plate 32 includes a metal layer (not shown) formed on its surface through a sputter deposition process. One of the protective films 34 located at a metal layer side of the metal sputtered base plate 32 is connected to the metal sputtered base plate 32 with adhesive.

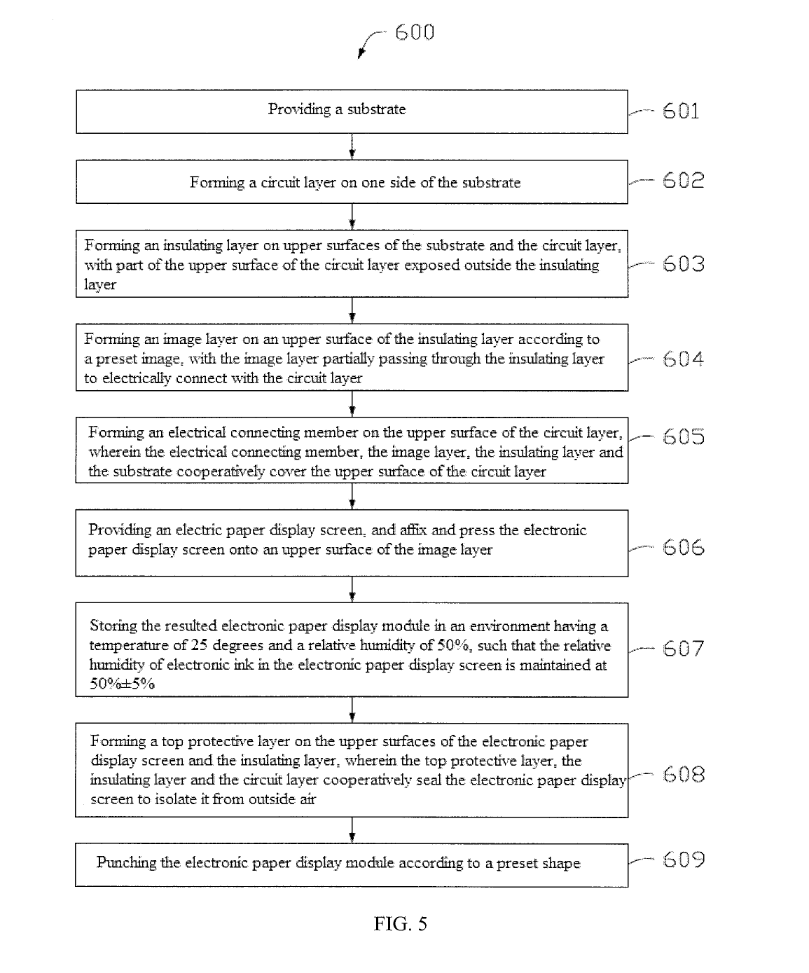

Referring to FIG. 5, the present invention provides a method 600 for making the above described electronic paper display module, which includes the following steps.

601: A substrate is provided. The substrate has a damp-resistant capability. The substrate includes a thin metal sheet and protective films disposed on opposite sides of the thin metal sheet. Alternatively, the substrate includes two protective films and a metal sputtered base plate sandwiched between the two protective films. The substrate may be cut into desired specification.

602: A circuit layer is formed on an upper surface of the substrate. The circuit layer may be formed by printing a conductive silver paste ink, or made from a metal through a sputtering, pressing or etching process.

603: An insulating layer is formed on the upper surface of the substrate and an upper surface of the circuit layer, with part of the upper surface of the circuit layer exposed outside the insulating layer. The insulating layer is formed by printing an insulating ink, or alternatively by affixing and pressing or coating an insulating material such as resin to the substrate or the circuit layer. The insulating layer seals three adjacent side surfaces of the circuit layer.

604: An image layer is formed on an upper surface of the insulating layer according to a preset image. The image layer partially passes through the insulating layer to electrically connect with the circuit layer. The image layer may be formed by printing a conductive carbon paste ink, or alternatively made from a metal through a sputtering, pressing or etching process.

605: An electrical connecting member is formed on an upper surface of the circuit layer, and the electrical connecting member, the image layer and the insulating layer cooperatively cover the upper surface of the circuit layer. The electrical connecting member may be formed by printing a conductive carbon paste ink, or alternatively made from an electrically conductive material such as an electrically conductive metal.

606: An electric paper display screen is provided, which is affixed and pressed on the upper surface of the image layer. The electronic paper display screen covers the upper surface of the image layer and has the same size as the image layer.

607: The resulted electronic paper display module is stored in an environment having a temperature of 25 degrees and a relative humidity of 50%, such that the relative humidity of electronic ink in the electronic paper display screen is maintained at 50%±5%.

608: A top protective layer is formed on the upper surface of the electronic paper display screen and the upper surface of the insulating layer. The top protective layer seals the electronic paper display screen and the image layer to isolate them from outside air. The protective layer may be formed by affixing or coating. When the protective layer is formed on the upper surface of the electronic paper display screen by affixing, the top protective layer is pressed to seal the electronic paper display screen and the image layer.

609: The electronic paper display module is punched according to a preset shape.

In the method for making the electronic paper display module of the present invention, the damp-resistant substrate (20, 30) is provided, and the circuit layer 40, the insulating layer 50 and the electronic paper display layer 70 are sequentially disposed on one side of the substrate (20, 30), such that the circuit layer 40 and the electronic paper display layer 70 can be sealed simply by affixing a top protective layer 90 to the electronic paper display module 400, thereby maintaining the relative humidity of the electronic ink in the electronic paper display layer 70 at 50%±5%. In comparison with the prior art, in making the electronic paper display module, the bottom protective layer is no longer required, which simplifies the fabrication process and reduces the cost.

Although the invention is described with reference to one or more embodiments, the above description of the embodiments is used only to enable people skilled in the art to practice or use the invention. It should be appreciated by those skilled in the art that various modifications are possible without departing from the spirit or scope of the present invention. The embodiments illustrated herein should not be interpreted as limits to the present invention, and the scope of the invention is to be determined by reference to the claims that follow.

1. An electronic paper display module comprising:
a substrate;
a circuit layer disposed on one side of the substrate;
an insulating layer disposed on the substrate and the circuit layer;
an electronic paper display layer disposed on one side of the insulating layer opposite from the circuit layer and partially passing through the insulating layer to electrically connect with the circuit layer;
an electrical connecting member, and
a top protective layer disposed on the insulating layer and the electronic paper display layer;
wherein the top protective layer, the insulating layer and the circuit layer cooperatively seal the electronic paper display layer to isolate the electronic paper display layer from outside air, and the circuit layer, the insulating layer, the electrical connecting member and the substrate cooperatively seal the circuit layer to isolate it from outside air.

2. The electronic paper display module of claim 1, wherein the substrate comprises a thin metal sheet and two protective films disposed on opposite sides of the thin metal sheet, and the circuit layer is disposed on one side of one of the two protective films opposite from the thin metal sheet.

3. The electronic paper display module of claim 2, wherein the two protective films are adhered to the thin metal sheet with adhesive.

4. The electronic paper display module of claim 1, wherein the substrate comprises a metal sputtered base plate and two protective films on opposite sides of the metal sputtered base plate, and the circuit layer is disposed on one side of one of the two protective films opposite from the metal sputtered base plate.

5. The electronic paper display module of claim 4, wherein the metal sputtered base plate comprises a metal layer formed on its surface through a sputter deposition process.

6. The electronic paper display module of claim 2, wherein a material of the protective film is one of polycarbonate, polymethyl methacrylate, polyethylene terephthalate, polyethersulfone, cellulose ester, polyvinyl chloride, benzocyclobutene and acrylic resin.

7. The electronic paper display module of claim 1, wherein the electronic paper display module comprises an image layer and an electronic paper display screen, the image layer is disposed on the insulating layer and partially passes through the insulating layer to electrically connect with the circuit layer, the image layer is pre-formed with images or characters that the electronic paper display module needs to display, and the electronic paper display screen is stacked on the image layer.

8. The electronic paper display module of claim 7, wherein the electronic paper display screen is one of a micro-capsule electrophoretic screen, a microcup electrophoretic screen, a gyricon bead electrophoretic screen, and a partition electrophoretic screen.

9. The electronic paper display module of claim 7, wherein the image layer is made of conductive carbon paste ink or metal.

10. The electronic paper display module of claim 1, wherein the electrical connecting layer is made of conductive carbon paste ink or metal, the circuit layer is made of conductive silver paste ink or metal, and the insulating layer is made of insulating ink or resin.

11. An electronic paper display device comprising an electronic paper display module, the electronic paper display module comprising:
a substrate;
a circuit layer disposed on one side of the substrate;
an insulating layer disposed on the substrate and the circuit layer;
an electronic paper display layer disposed on one side of the insulating layer opposite from the circuit layer and partially passing through the insulating layer to electrically connect with the circuit layer;
an electrical connecting member, and
a top protective layer disposed on the insulating layer and the electronic paper display layer;
wherein the top protective layer, the insulating layer and the circuit layer cooperatively seal the electronic paper display layer to isolate it from outside air, and the circuit layer, the insulating layer, the electrical connecting member and the substrate cooperatively seal the circuit layer to isolate it from outside air.

12. The electronic paper display device of claim 11, wherein the electrical connecting layer is made of conductive carbon paste ink or metal, the circuit layer is made of conductive silver paste ink or metal, and the insulating layer is made of insulating ink or resin.

13. The electronic paper display device of claim 11, wherein the electronic paper display module comprises an image layer and an electronic paper display screen, the image layer is disposed on the insulating layer and partially passes through the insulating layer to electrically connect with the circuit layer, the image layer is pre-formed with images or characters that the electronic paper display module needs to display, and the electronic paper display screen is stacked on the image layer.

14. The electronic paper display device of claim 11, wherein the substrate comprises a thin metal sheet and two protective films disposed on opposite sides of the thin metal sheet, and the circuit layer is disposed on one side of one of the two protective films opposite from the thin metal sheet.

15. A method for making an electronic paper display module, comprising the steps of:
providing a substrate;
forming a circuit layer on one side of the substrate;
forming an insulating layer on the substrate and the circuit layer, with part of the circuit layer exposed outside the insulating layer;
forming an image layer on one side of the insulating layer opposite from the circuit layer according to a preset image, with the image layer partially passing through the insulating layer to electrically connect with the circuit layer;
forming an electrical connecting member on the circuit layer, wherein the electrical connecting member, the image layer, the insulating layer and the substrate cooperatively seal the circuit layer to isolate it from outside air;
providing an electric paper display screen, and affixing and pressing the electronic paper display screen onto one side of the image layer opposite from the insulating layer;
storing the resulted electronic paper display module in an environment having a temperature of 25 degrees and a relative humidity of 50%, such that the relative humidity of electronic ink in the electronic paper display screen is maintained at 50%±5%; and
forming a top protective layer on the electronic paper display screen and the insulating layer, wherein the top protective layer, the insulating layer and the circuit layer cooperatively seals the electronic paper display screen to isolate it from outside air.

16. The method for making the electronic paper display module of claim 15, wherein the circuit layer is formed by printing a conductive silver paste ink, or from a metal material through a sputtering, pressing, etching or laser process.

17. The method for making the electronic paper display module of claim 15, wherein the insulating layer is formed by printing an insulating ink, or by affixing and pressing or coating resin.

18. The method for making the electronic paper display module of claim 15, wherein the image layer is formed by printing a conductive carbon paste ink, or from a metal material through a sputtering, pressing, etching or laser process.

19. The method for making the electronic paper display module of claim 15, wherein the electrical connecting member is formed by printing a conductive carbon paste ink, or made from metal.

20. The method for making the electronic paper display module of claim 15, further comprising punching the electronic paper display module according to a preset shape after the top protective film is formed.
